(19) United States
(12) Patent Application Publication
(10) Pub. No.: US 2022/0017273 A1
(43) Pub. Date: Jan. 20, 2022

(54) CONTAINER AND CLOSURE WITH ANTI-MISSILING CHANNELS

(71) Applicants: Philip Andrew WALTON, Bishop Auckland Durham (GB); Sergio SONZOGNI, Bergamo (IT)

(72) Inventors: Philip Andrew WALTON, Bishop Auckland Durham (GB); Sergio SONZOGNI, Bergamo (IT)

(21) Appl. No.: 17/292,461

(22) PCT Filed: Nov. 8, 2019
(86) PCT No.: PCT/GB2019/053179

§ 371 Date: May 10, 2021

(30) Foreign Application Priority Data
Nov. 9, 2018 (GB) 1818333.5

(51) Int. Cl. B65D 51/16; B65D 1/02

(52) U.S. Cl. CPC B65D 51/1688; B65D 1/0246

(57) ABSTRACT

A container for pressurised liquid has a closure (V) engaged on the neck (N), both formed of yieldable polymer. The closure (V) has an end wall (21) and a skirt (20) provided with internal screw threads (24) which co-operate with external screw threads (23) on the neck to hold the closure in place. A pressure seal (25) is formed between the mouth (22) of the neck and the end wall (21) of the closure when the closure is screwed onto the neck whereby the pressurised liquid is retained within the container. To prevent missiling when the closure (V) is unscrewed the proximal face (28) of the external screw threads (23) is formed with transverse venting channels (36) extending from the base (26) of the respective screw threads to their outer extremity (27). The distal face (29) of the external screw threads (23) opposite each of the venting channels (36) is substantially continuous. This avoids weakening the neck of the container and reduces the risk of long-term creep.

### TECHNICAL FIELD OF THE INVENTION

This invention relates to containers and closures for holding pressurised liquids. The invention is applicable to closures which incorporate valves, as used with carbonated beverage containers such as beer kegs, and which are configured to enable the liquid contents to be dispensed by gas pressure.

### BACKGROUND

A great number of containers are used to house pressurized liquids, for example carbonated beverages. Such containers have a narrowed neck which is closed with a screw-on cap. Gaps are normally left between the threads to enable the cap to be easily screwed into the neck without being hindered by friction. The cap and the neck have opposed sealing surfaces which come into engagement when the cap is tightened to prevent leakage and maintain the internal pressure. In addition, when the cap is tightened, opposing surfaces of the respective screw threads on the neck and cap are also drawn together. If the thread forms are continuous, and the male and female components closely aligned with the same pitch, the internal pressure will be substantially maintained during cap removal. When such a cap is partially unscrewed, although the sealing surfaces are open, the threads can still maintain a seal due to the upward force exerted on the cap by the internal gas pressure which draws the threads into sealing engagement. During removal of the cap, gas may still be vented along the length of the threads due to the gaps between them, but since this path is often narrow and follows the helical path of the threads the venting channel is long and restrictive so that the rate of venting is very slow. This is undesirable as it means the cap could be forcibly ejected as it is finally unscrewed, resulting in a co-called missiling condition where the cap acts as a high velocity projectile. As the internal pressures can be typically 2 to 3 bar for carbonated beverages this can represent a dangerous situation.

The missiling problem is especially important in the case of beer kegs. Such kegs normally have a closure incorporating a twin valve arrangement which facilitates the simultaneous introduction of the dispense gas and extraction of the beverage. These valves also provide access for filling the keg with beverage and they normally open and close both paths upon connection and disconnection. In small carbonated beverage bottles the internal pressure is reduced as the beverage is consumed thus leaving the bottle without internal pressure when empty. But with kegs, additional gas is introduced to dispense the beverage during normal use, often at pressures in excess of 5 bar. Thus, when the keg is empty of beverage the full internal pressure can still remain. When the valve closure is removed (for example during recycling of the container) an extremely dangerous situation exists.

To address the missiling problem various methods have been employed. One common solution is to introduce circumferential gaps into the thread, as disclosed in U.S. Pat. Nos. 2,990,079, 4,007,848 and EP 0 009 854 A1. These channels create axial venting paths for the internal gas to escape during the unscrewing operation, so that venting occurring as soon as the sealing surfaces are opened but while the threads remain substantially engaged. However, although such venting channels can be effective in venting the internal gas during cap removal they can be problematic in the case of containers such as beer kegs which are subjected to higher internal pressures. The gaps in the thread can substantially reduce the physical strength of the neck as the thinner sections create weak areas. Since high pressure containers and valve closures are increasingly being moulded of yieldable polymers (plastics) the internal pressures can lead to gradual distortion of the components (so-called creep) and potential failure.

EP 0 060 218 A2 addresses the risk of a screw-cap jumping off when it is screwed on. Spacer cams are provided on the thread flanks to produce a venting channel between the flanks. In high pressure containers, such as beer kegs, spacer cams would tend to become flattened under sustained high pressure. The provision of projections on the threads would therefore risk an inadequate and uncertain level of venting as the closure is released. Furthermore, due to creep, distortion of the intervening thread portions could occur, thereby weakening the screwed connection.

### SUMMARY OF THE INVENTION

When viewed from one aspect the present invention proposes a container having a container body (C) to hold pressurised liquid and a neck (N) with a closure (V) engaged on said neck;
wherein said container neck (N) and said closure (V) are both formed of yieldable polymer;
wherein the neck has a mouth (22) providing access to the interior of the container body (C);
wherein the closure (V) has an end wall (21) and a skirt (20);
wherein the skirt (20) is provided with internal screw threads (24) which co-operate with external screw threads (23) on the neck to hold the closure on the container body;
wherein each of the screw threads (23, 24) has a root (26, 30) where the respective screw thread (23, 24) is joined to the neck (N) or skirt (20) and an outer extremity (27, 31) remote from the neck or skirt;
wherein each of the screw threads (23, 24) has a proximal face (28, 32) closest to the container body (C) and an opposite distal face (29, 33), each of said proximal and distal faces extending from the root (26, 30) of the respective screw thread to the outer extremity (27, 31) thereof;
wherein a pressure seal (25) is formed between the mouth (22) of the neck and the end wall (21) of the closure when the closure is screwed onto the neck whereby the pressurised liquid is retained within the container;
   characterised in that the proximal face (28) of the external screw threads (23) and/or the distal face (33) of the internal screw threads (24) is formed with transverse venting channels (36) extending from the base (26, 30) of the respective screw threads to the outer extremity thereof (27, 31), and wherein the the distal face (29) of the external screw threads (23) and/or the proximal face (32) of the internal screw threads opposite each of the venting channels (36) is substantially continuous.

In a preferred embodiment the venting channels (36) are provided in successive turns of the screw thread (23, 24) and are axially aligned.

In a preferred embodiment a plurality of venting channels (36) are provided in each turn of the screw thread (23, 24).

In a preferred embodiment the venting channels (36) occupy less than 30% of each complete circumferential turn of the screw thread (23, 24), most preferably less than 20%.

In a preferred embodiment the closure (V) has:
a gas inlet port (11),
a liquid dispensing port (12),
valve means (6) to sealably close the gas inlet and liquid dispensing ports.

### BRIEF DESCRIPTION OF THE DRAWINGS

The following description and the accompanying drawings referred to therein are included by way of non-limiting example in order to illustrate how the invention may be put into practice. In the drawings:

FIG. 1 is an axial section through an A-type valve closure as used in a beer keg, shown in a closed configuration;

FIG. 2 is a similar axial section through the valve closure in the dispensing configuration;

FIG. 3 is a further axial section through a simplified version of the valve closure showing the closure sealingly engaged with the neck of the container;

FIG. 4 is an enlarged detail showing the screw threads which hold the valve closure onto the neck of the container;

FIG. 5 is another axial section showing the closure engaged with the neck of the container during removal therefrom;

FIG. 6 is a general view of the container neck showing the venting channels;

FIG. 7 is a detailed axial section through one vent path between the closure and container neck during removal of the closure.

### DETAILED DESCRIPTION OF THE DRAWINGS

For the purpose of example the valve closure shown in the drawings is of the kind known as an A-type valve. All components of the valve closure may be moulded of polymeric materials (plastics) so that the closure is fully recyclable. A preferred form of valve closure is described in EP 2 585 400 A1.

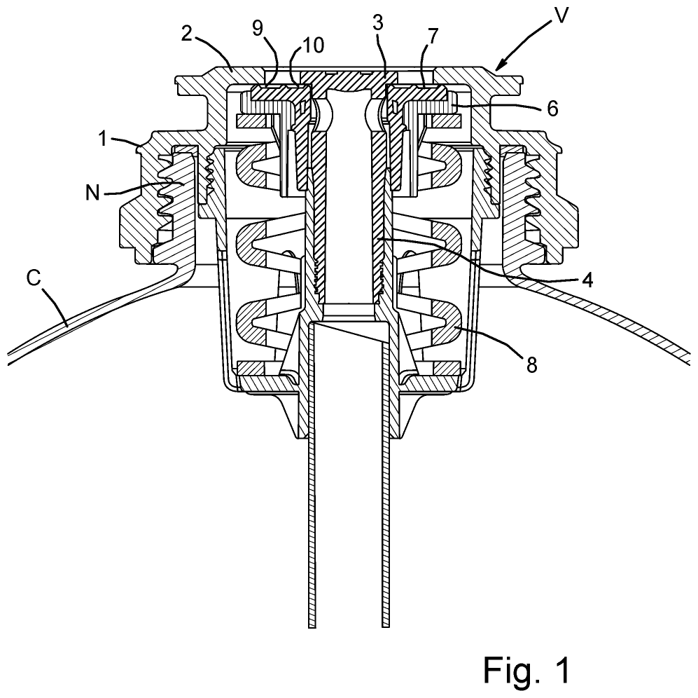

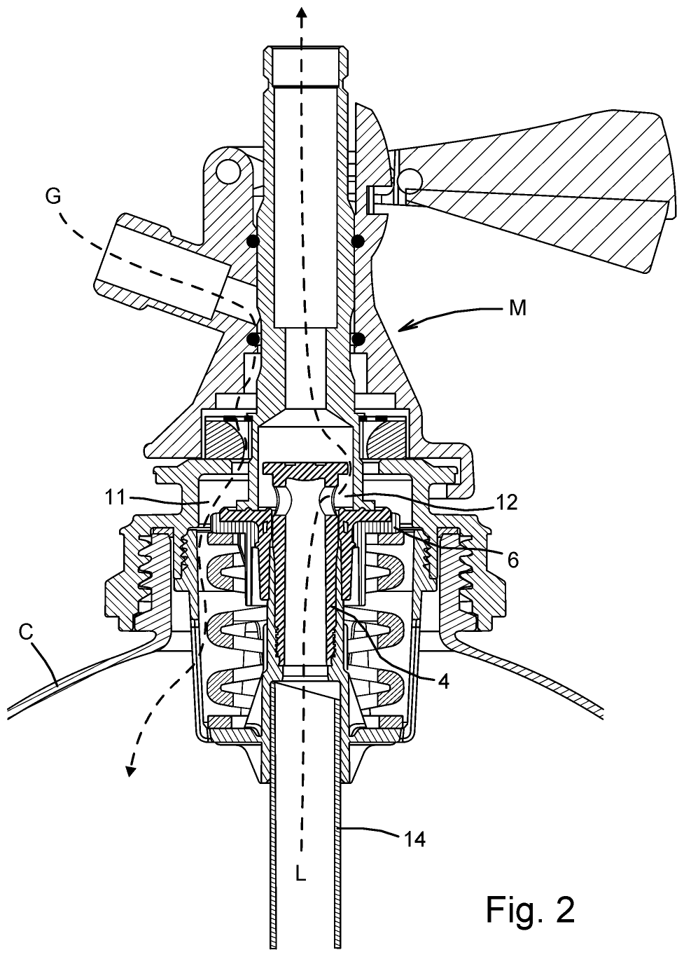

Referring firstly to FIG. 1, the valve closure V comprises a closure body 1 which is adapted to be fitted onto the neck N of a beverage container C such as a beer keg, which is typically formed by stretch blow moulding. The closure body has an annular top wall 2 which is concentric with a fixed disc-shaped cap 3 formed at the upper end of a hollow core pin 4. A valve member 6 includes a resilient seal 7 and is spring-loaded by a compression spring 8 which sealingly urges the valve member against an outer valve seat 9 formed around the inner periphery of the annular top wall 2 and an inner valve seat 10 formed around the periphery of the cap 3. To dispense a liquid product from the container the valve member 6 is engaged by a cylindrical valve-operating member M as in FIG. 2. The valve member 6 is depressed against its spring-loading and makes sealing contact with the valve-operating member M to provide separate gas and liquid flow paths past the valve-operating member, indicated by the broken arrows G and L respectively. Pressurised gas is fed into the container C through a gas inlet port 11. Liquid simultaneously flows out of the container through a draw tube 14 and the core pin 4, exiting through a liquid dispensing port 12. When dispensing is finished and the valve-operating member M is disconnected, the valve member 6 returns to the sealing condition shown in FIG. 1, holding the internal gas pressure within the container together with any remaining liquid.

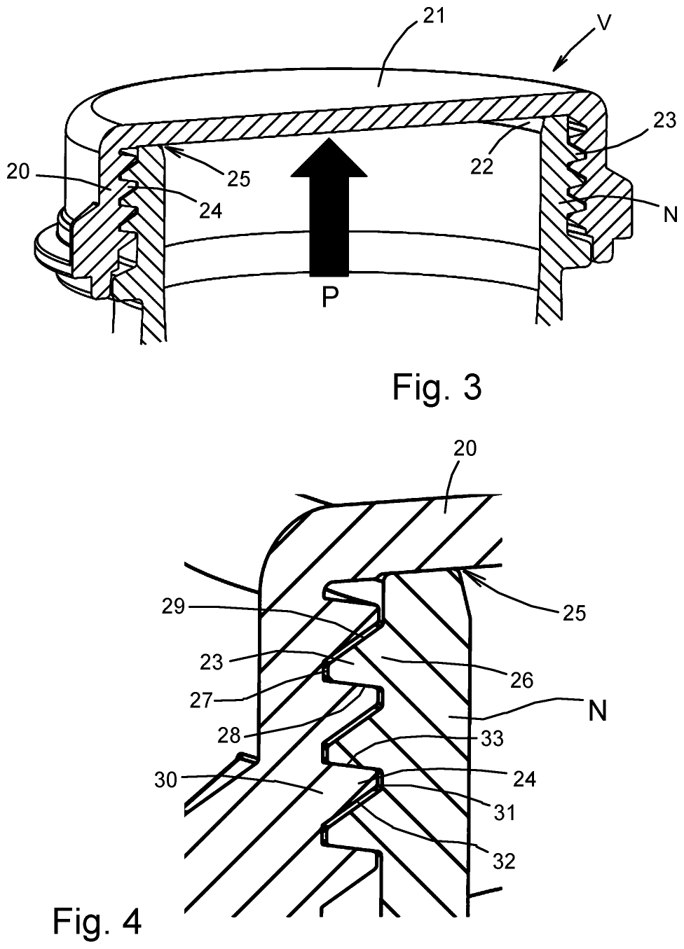

In FIG. 3, the valve closure V is represented by an outer skirt 20 which is part of the closure body 1, and an end wall 21 which incorporates the annular top wall 2. The valve member 6 and the associated components have been omitted from this and later drawings for clarity. As explained above, the container neck N and closure V are both mounded of yieldable polymer. The neck N is generally cylindrical with a mouth 22 providing access to the interior of the container body C. The neck is also provided with moulded external screw threads 23 in the form of a single helix. The skirt 20 of the closure V is also generally cylindrical and is provided with internal screw threads 24, also forming a single helix, which co-operate with the complimentary external screw threads 23 on the neck N to hold the closure on the container. The mouth 22 of the neck N and the end wall 21 of the closure V are configured to form a pressure seal 25 when the closure V is screwed onto the neck N, which retains the internal gas pressure of the pressurised liquid within the container C, the force of the internal pressure being represented by the arrow P. This seal 25 may be achieved by opposing planar faces of the neck N and the closure V as shown, although separate sealing rings may be interposed or formed integrally with one or both of the opposing surfaces, as required.

Although the screw threads 23 and 24 have substantially the same pitch and a complimentary profile as shown in FIG. 4, they are formed with a small gap between them to avoid mutual friction which could impede screwing-on of the closure. As viewed in cross section, the external threads 23 on the neck N have a root 26 where the respective thread is joined to the neck N, an outer extremity 27 remote from the neck, a proximal face 28 closest to the container body C and an opposite distal face 29 closest to the mouth 22. The proximal and distal faces 28 and 29 both converge from the root 26 of the respective screw thread to the outer extremity 27. The proximal face 28 will generally be inclined at a steeper angle to the neck N than the distal surface 29, as shown, and is therefore the shorter of the two. The complimentary internal screw threads 24 on the skirt 20 have a root 30 where the respective thread is joined to the skirt, an outer extremity 31 remote from the skirt, a proximal face 32 closest to the container body and an opposite distal face 33, each of said proximal and distal faces 32 and 33 extending from the root 30 of the respective screw thread to the outer extremity 31. The distal face 33 is inclined at a steeper angle than the proximal face 32 to match the proximal face 28 of the neck threads 23. When the cap is tightened to make the seal 25 provided by the co-operating sealing surfaces of the end wall 20 and neck N, the distal surface 33 of the threads 24 is drawn into contact with the opposing proximal face 28 of the threads 23, as shown.

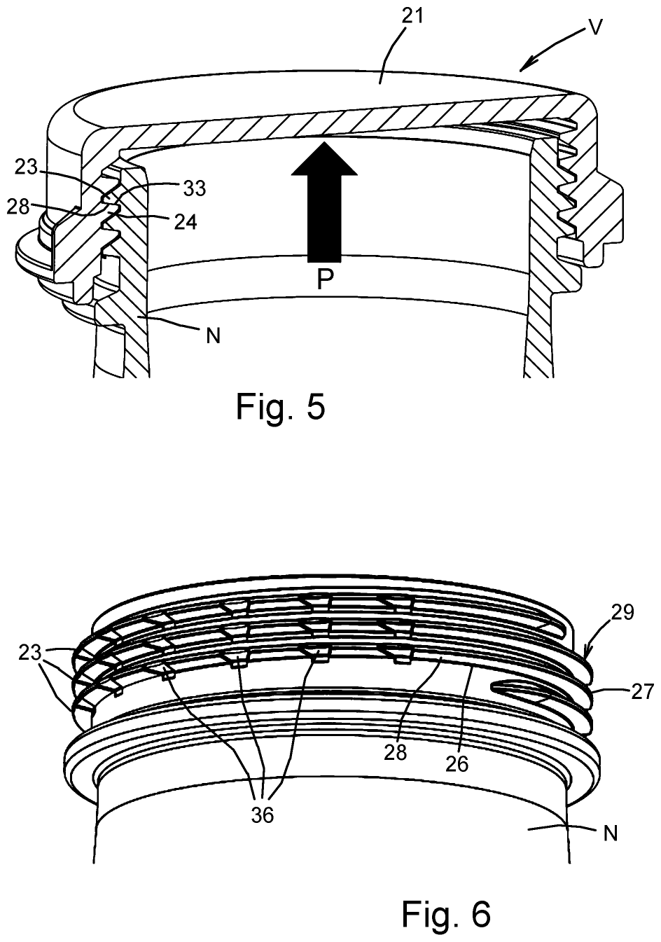

During removal of the closure V, shown in FIG. 5, the opposing surfaces of the end wall 21 and the neck N are no longer in sealing contact but the internal pressure P acting on the end wall 21 continues to draw the distal surface 33 of the thread 24 into contact with the opposing proximal surface 28 of the thread 23, effectively providing a secondary seal between the neck N and the closure V. Although gas may be vented along the length of the threads due to the gaps between them, the rate of venting by this route is normally very slow.

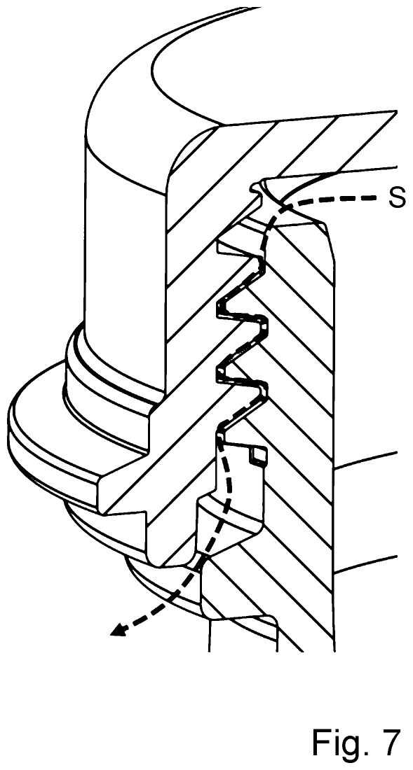

In the present closure, as shown in FIG. 6, the proximal face 28 of the external screw threads 23 on the neck N is formed with transverse venting channels 36 each extending from the root 26 to the outer extremity 27. The distal face 29 of the neck screw threads opposite each of the venting channels 36 is substantially continuous.

The venting channels 36 are provided in successive turns of the screw threads 23 and are axially aligned, as shown. Furthermore, a number of venting channels are provided in each turn of the screw thread, which may be arranged in groups, for example six channels on each side of the neck. These channels provide a short unobstructed transverse path across the mating surfaces of the two threads, 23 and 24, and as shown in FIG. 7 which is a section through the venting channels, create a path S for the gas to escape which is substantially shorter than the helical path of the thread. Furthermore, the total cross-sectional area of the combined venting paths is substantially greater than a single helical path following the threads.

The venting channels 36 occupy less than 30% of each complete circumferential turn of the screw thread 23, and preferably less than 20%. The channels have minimal impact on the cross sectional form of the thread so that the strength afforded to the neck by the screw thread is not significantly reduced. Moreover, there is little or no tendency to distortion due to creep under sustained gas pressure.

The arrangement described therefore provides relatively rapid venting while substantially maintaining the physical strength of the neck.

It will be appreciated that similar venting channels could be formed in the mating distal faces 33 of the closure threads 24 instead of, or in addition to, the proximal faces of the neck threads 23, but it is generally easier to mould the venting channels into an external thread.

Although the venting arrangement can be applied to any closure for pressurised containers it is particularly useful in the case of valve closures which are subject to relatively high gas pressures over a sustained period such as the A-type closure described. The venting mechanism can be applied to all the common valve formats A, G, S, D and M types. An A-type valve is similar to a G-type valve. Both have a fixed central core pin and a single spring-loaded valve member which controls two ports. Other forms of valve closure are also used with beer kegs. Operationally, S, D and M types are similar to each other in that they all have no fixed central core pin but have two concentric spring-loaded moving valve members which separately control the two ports. Generally the valve members are operated by respective spring elements, but the valve members may be cascaded such that closure of one spring-loaded valve member causes closure of the other.

Whilst the above description places emphasis on the areas which are believed to be new and addresses specific problems which have been identified, it is intended that the features disclosed herein may be used in any combination which is capable of providing a new and useful advance in the art.

1. A container having a container body (C) to hold pressurised liquid and a neck (N) with a closure (V) engaged on said neck;
wherein said container neck (N) and said closure (V) are both formed of yieldable polymer;
wherein the neck has a mouth (22) providing access to the interior of the container body (C);
wherein the closure (V) has an end wall (21) and a skirt (20);
wherein the skirt (20) is provided with internal screw threads (24) which co-operate with external screw threads (23) on the neck to hold the closure on the container body;
wherein the internal screw threads (24) and the external screw threads (23) are each in the form of a single helix comprising complete circumferential turns;
wherein each of the screw threads (23, 24) has a root (26, 30) where the respective screw thread (23, 24) is joined to the neck (N) or skirt (20) and an outer extremity (27, 31) remote from the neck or skirt;
wherein each of the screw threads (23, 24) has a proximal face (28, 32) closest to the container body (C) and an opposite distal face (29, 33), each of said proximal and distal faces extending from the root (26, 30) of the respective screw thread to the outer extremity (27, 31) thereof;
wherein a pressure seal (25) is formed between the mouth (22) of the neck and the end wall (21) of the closure when the closure is screwed onto the neck whereby the pressurised liquid is retained within the container;
characterised in that the proximal face (28) of the external screw threads (23) and/or the distal face (33) of the internal screw threads (24) is formed with transverse venting channels (36) extending from the base (26, 30) of the respective screw threads to the outer extremity thereof (27, 31), and wherein the the distal face (29) of the external screw threads (23) and/or the proximal face (32) of the internal screw threads opposite each of the venting channels (36) is substantially continuous.

2. A container according to claim 1 wherein the venting channels (36) are provided in successive turns of the screw thread (23, 24) and are axially aligned.

3. A container according to claim 1 wherein a plurality of venting channels (36) are provided in each turn of the screw thread (23, 24).

4. A container according to claim 1 wherein the venting channels (36) occupy less than 30% of each complete circumferential turn of the screw thread (23, 24).

5. A container according to claim 1 wherein the venting channels (36) occupy less than 20% of each complete circumferential turn of the screw thread (23, 24).

6. A container according to claim 1 wherein the closure (V) has:
a gas inlet port (11),
a liquid dispensing port (12),
valve means (6) to sealably close the gas inlet and liquid dispensing ports.
